(19) United States
(12) Patent Application Publication
(10) Pub. No.: US 2023/0410288 A1
(43) Pub. Date: Dec. 21, 2023

(54) METHOD FOR MEASURING THE INFLUENCE OF A TRANSPARENT PANE

(71) Applicant: Robert Bosch GmbH, Stuttgart (DE)

(72) Inventors: Andre WAGNER, Hannover (DE); Moritz Michael Knorr, Hildesheim (DE); Beke Junge, Hildesheim (DE); Henning von Zitzewitz, Hemmingen (DE); Oliver Lange, Hemmingen (DE); Stephan Simon, Sibbesse (DE)

(21) Appl. No.: 18/247,980

(22) PCT Filed: Oct. 18, 2021
(86) PCT No.: PCT/EP2021/078805

§ 371 Date: Apr. 5, 2023

(30) Foreign Application Priority Data
Dec. 7, 2020 (DE) 10 2020 215 417.1

(51) Int. Cl. G06T 7/00; G06T 7/269

(52) U.S. Cl. CPC G06T 7/001; G06T 2207/30252; G06T 7/269

(57) ABSTRACT

A method for measuring the influence of a transparent pane. In the method, a displacement field induced by the pane is determined. In a first step, a first image of a textured surface without the transparent pane is acquired; in a second step, a second image of the textured surface with the transparent pane is acquired; and in a third step, the displacement field is determined by analyzing the two images using an optical flow method.

### FIELD

The present invention relates to a method for measuring the influence of a transparent pane, e.g., a windshield, and an arrangement for performing the method.

### BACKGROUND INFORMATION

A windshield, also referred to as a front window, is a pane, regularly made of glass, e.g., laminated glass, that allows the driver of a vehicle to see forward. At the same time, the windshield provides the driver with protection from wind, weather and particles in the airflow. The method described below is not limited to front windows but can likewise be used for camera systems behind rear windows or other vehicle windows. Below, the case of a front window is considered as a typical application.

When light shines or radiates through a windshield, it is refracted by the transparent medium. Due to the curvature of the windshield itself as well as variations in thickness, curvature or local changes in the material properties, this refraction and thus the influence of the windshield on the optical path are difficult to predict. Although individuals often estimate this influence to be minor, it may greatly influence the function of camera systems that are typically installed very closely to the windshield.

This is in particular of importance for modern camera-based driver assistance systems or advanced driver assistance systems (ADAS). The influence of the windshield, if not considered, can, for example, result in incorrect estimates with respect to the position or speed of objects. The influence can be described with a so-called displacement field. The pane induces, by refraction, an offset of view beams and an angular change. The offset is typically small and does not change over distance. However, at greater distances, the angular offset results in greater errors, according to the angles. In particular, the second effect, i.e., the induced angular change, is therefore to be determined using the displacement field.

Various methods are used to determine the displacement field of a windshield. In the automotive industry, so-called Moire interferometers are primarily used to measure the angular change produced by the pane. However, the information thus obtained is difficult to transfer to the specific displacement field of a camera mounted closely to the windshield.

Other methods are based on determining the displacement field using a camera and an accurately known calibration body. The distortion effects of the windshield are calculated by determining the displacement in the image or image space with knowledge of the calibration body.

### SUMMARY

A method and an arrangement according to the present invention are provided. Example embodiments of the present invention are disclosed herein.

The method of the present invention presented serves to measure a transparent pane, in particular with high accuracy, for example for camera systems, wherein the influence of this pane is quantified or measured. The pane, e.g., a windshield, is typically to be mounted in front of the camera or is mounted there. According to an example embodiment of the present invention, the method provides that a displacement field induced by the transparent pane is determined. In this case, a first image of a textured surface without the pane is acquired in a first step, and a second image of the textured surface with the pane is acquired in a second step. In a third step, the displacement field is determined by analyzing the two images using an optical flow method.

The described method of the present invention is not limited to windshields or front windows but can likewise be used for camera systems behind rear windows or other vehicle windows. Below, the case of a windshield is considered as a typical application.

Acquiring an image with the pane means that during the acquisition, the pane is located between the camera and the textured surface and thus in the beam path between the camera and the textured surface. Accordingly, when acquiring an image without the pane, no pane is arranged at that location.

A texture or textured surface is to be understood to mean that the surface has a particular pattern. Particularly suitable for this method are textures with random patterns, e.g., noise patterns, that have a wide range of spatial frequencies. Such a pattern can be generated, for example, by superimposing noise patterns of different frequencies, wherein, for example, Perlin noise is used.

The method according to the present invention disclosed herein makes it possible to determine the displacement field that is induced by a windshield and results in the image space of a camera. The displacement field here refers to the geometric displacement of objects in the image space, e.g., by elongation, stretching, displacement, etc., which results from the changed beam path.

Further advantages and embodiments of the present invention arise from the description and the figures.

It is understood that the aforementioned features and the features yet to be explained below can be used not only in the respectively specified combination but also in other combinations or on their own, without leaving the scope of the present invention.

### BRIEF DESCRIPTION OF THE DRAWINGS

FIG. 1 shows a schematic representation of a windshield and a camera.

FIG. 2 shows the procedure for a highly accurate calibration, according to an example embodiment of the present invention.

FIG. 3 shows an experimental setup for determining a displacement field, according to an example embodiment of the present invention.

FIG. 4 shows an experimental setup with illuminated random pattern, according to an example embodiment of the present invention.

FIG. 5 shows an example of a displacement field determined using the described method according to the present invention.

FIG. 6 shows a displacement field projected onto a curtain, according to an example embodiment of the present invention.

### DETAILED DESCRIPTION OF EXAMPLE EMBODIMENTS

The present invention is illustrated schematically in the drawings on the basis of embodiments and is described in detail below with reference to the figures.

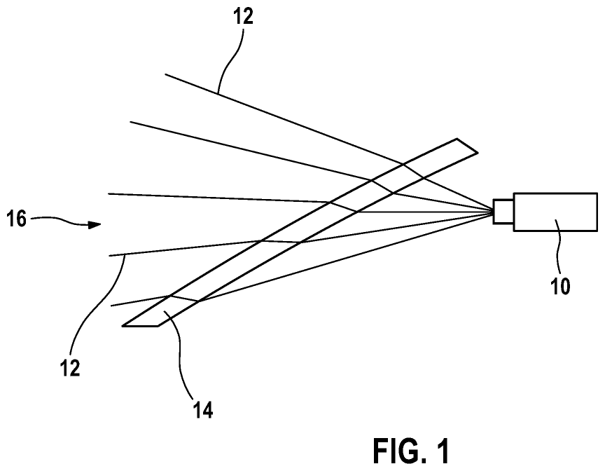

FIG. 1 shows a schematic representation of the geometric deflection of the view beams 12, which originate from a camera and define a beam path 16, through a windshield 14. In the area of the windshield 14, this deflection and thus the influence of the windshield 14 on the beam path 16, starting from the camera 10 in this case, can be clearly seen. The changed beam path 16 results in both an offset with respect to the position and a change in direction of the view beams 12. Especially the latter is critical at greater distances between the camera 10 and objects.

In the comparison between two images acquired by a camera with and without a windshield, a displacement field between the images results. That is to say, portions of the image are compressed, stretched, or displaced, and thus changed. The displacement field is thus a vector field that represents a mathematical description of this change. This can be used to describe for each structure visible in the image where it has been displaced to.

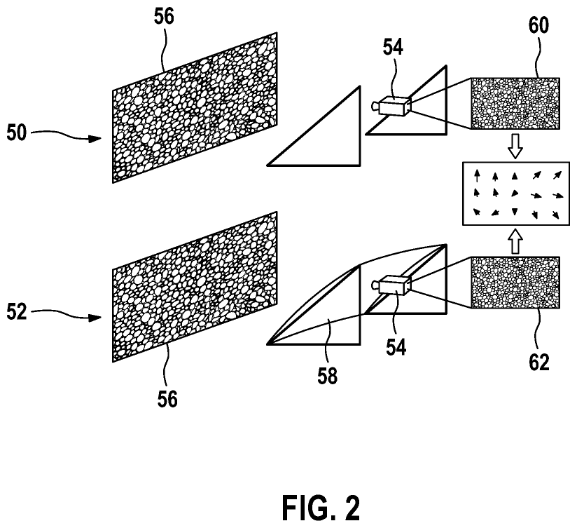

The method proposed herein now allows to determine this displacement field with comparatively simple means and existing methods highly accurately and densely, i.e., for every pixel of the target camera system. In doing so, an image of a textured surface with and without a windshield is respectively acquired using the target camera system. Afterwards, a method for determining dense displacement fields with respect to an optical flow in the image is used to determine the displacement field. This is shown schematically in FIG. 2.

FIG. 2 illustrates the procedure for a highly accurate calibration. The illustration shows an image without a windshield at the top 50 and an image with a windshield at the bottom 52. The illustration shows a camera 54 and a textured surface 56 at the top 50 and at the bottom 52, and a windshield 58 at the bottom 52.

First, a first image 60 of the textured surface 56 without a windshield is acquired. Subsequently, a second image 62 with a windshield 58 is acquired. By analyzing the images 60, 62 using an optical flow method, the displacement field is determined.

In doing so, for each point in the first image, the associated point in the second image is determined, wherein it is assumed that the appearance, e.g., change in image brightness, or features derived therefrom have high similarity in both images. This procedure can determine a dense vector field, which means that displacement information at every or nearly every pixel is available.

It should be noted in this respect that the imaged texture should have some particular properties that are however easy to produce. In some cases, suitably textured surfaces can also be found in the free environment.

Similarly to the textures produced, there should be a random pattern that has sufficiently strong local contrasts. This could, for example, be a house wall that has been exposed to severe weather effects. On the other hand, monotonous areas, such as a blue sky, should be avoided.

Until now, highly accurate calibration bodies that work with special methods for the detection of special markings are used to measure windshields. The method proposed herein, on the other hand, does not require prior knowledge of the textured surface, imposes few conditions on the physical nature thereof, and allows the use of common methods for determining the dense displacement field.

On the one hand, the method can be used to determine the characteristic of a series of windshields, or even during ongoing operation of the production. The assessment or release of a windshield can thus directly depend on the result of the measurement.

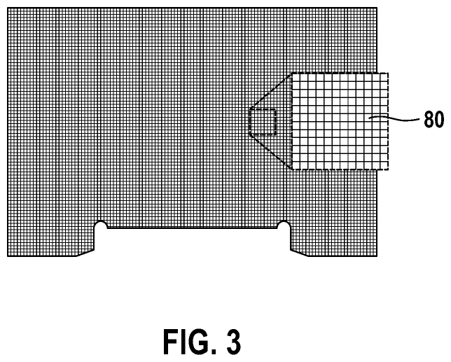

As already explained above, various methods are used to determine a displacement field of a windshield. Moiré interferometers are primarily used in this respect. However, the information thus obtained is difficult to transfer to the specific displacement field of a camera mounted closely to the windshield. Other methods are based on determining the displacement field using a camera and an accurately known calibration body. Such a calibration body is shown in FIG. 3.

FIG. 3 shows a possible experimental setup for determining, using a known and highly accurate calibration body 80, the displacement field induced by a pane in front of a camera. This calibration body 80 can be a field with a checkerboard pattern, for example.

With the proposed method, the goal is now to determine the displacement field that is induced by a windshield and results in the image space of a camera. The displacement field here refers to the geometric displacement of objects in the image space, such as elongation, stretching, displacement resulting from the changed beam path.

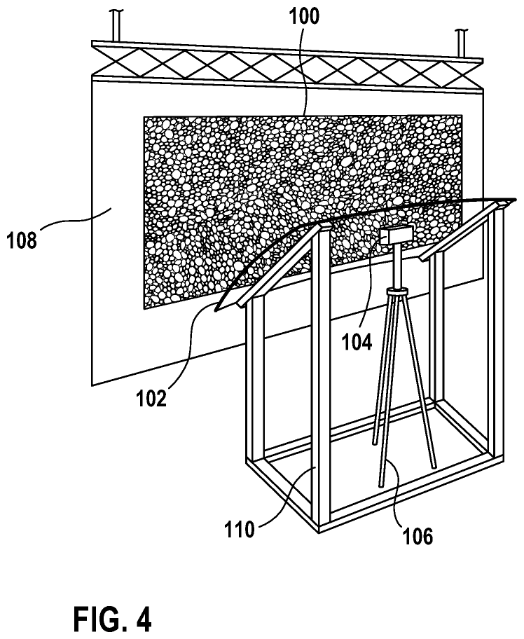

We describe a possible setup below. Alternatives to the setup and the general procedure are also described below. The setup is shown schematically in FIG. 2 and in the real-world setup in FIG. 4.

FIG. 4 shows an experimental setup with illuminated random pattern 100 and a camera 104 placed behind a windshield 102. The camera 104 is set up on a tripod 106 in front of a wall 108. Either the wall 108 itself has a special texture, or the latter is projected onto the wall 108 via a projector. A supporting stand 110 for the windshield 102 is placed between the camera 104 and the wall 108 such that the camera 104 assumes its typical installation position, i.e., position and orientation, relative to the windshield 102. Next, at least one image with and without the windshield 102 in place is respectively acquired using the camera 104. The displacement field in the image is determined using a method for determining displacement fields in the image space, commonly referred to as optical flow.

Generally, the imaging characteristics of the camera 104 without the windshield 102 are known or can be determined simply, namely more simply than with the windshield 102 mounted. For calibrating the camera 104, a measuring system is typically used, in which the camera 104 is clamped in a special mount and an accurately known calibration body is used. Such a procedure is not possible with one or more installed camera(s). Thus, the relationship between view beam angles and pixels for the camera without a windshield is known. Using the displacement field, a corrected pixel-view beam relationship (with the windshield) can now be calculated.

It should be noted in this respect that the introduction of an optical element, such as the windshield 102, always has two effects, the changed angular relationship on the one hand and an offset of the view beam, as shown in FIG. 1, on the other hand. The latter is often not relevant in practice since objects of interest are in many cases far away, e.g., several meters, and the influence of the offset is thus negligible. However, this offset can be determined by means of several images, as described above, with different distances to the wall 108. This may be of interest for other applications.

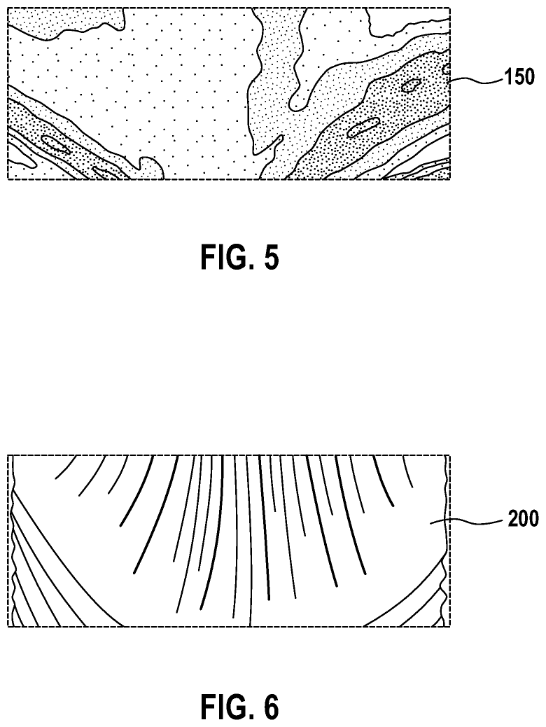

In FIG. 5, a displacement field 150 determined using the method is shown. A measurement by the dense optical flow method at each image point is available here. Only the horizontal displacement is shown here. The strength may be color-coded.

Textures that have strong local contrasts and are as random as possible, such as a random noise pattern, are in particular suitable for optical flow methods. In order that the texture also works for different distances to the camera and cameras with different resolutions, i.e., pixels per degree, the pattern should ideally have different local spatial frequencies. The pattern does not have to be known in advance.

In comparison to conventional methods with highly accurate calibration bodies, such as shown in FIG. 3, for example, the method proposed herein has many advantages.

For example, the random texture makes it possible to determine the displacement field at every pixel when a dense optical flow method is used. For calibration bodies, this is typically not possible at all locations. In the arrangement of FIG. 3, this is only possible at the intersection points. Dense optical flow methods are conventional.

Furthermore, suitable optical flow methods can achieve very high accuracy, namely far below the size of a pixel. The accuracy of the method is thus directly related to the accuracy of the underlying optical flow method but not to the accuracy of a calibration body.

By using different spatial frequencies in the random texture, the pattern can also be used at very different distances or camera image resolutions. This is not easily possible with typical calibration bodies in many cases.

In addition, it should be considered that the creation of the textured surface allows much freedom. For example, a textured film may be applied to a wall or a pattern may simply be projected using one or more projectors.

Ideally, the textured surface is at a similar distance from the camera and windshield as objects in a real situation, i.e., several meters. This is because the offset induced by the windshield has a similar influence. For cameras with larger aperture angles, this requires very large surfaces. With a horizontal aperture angle of 90 degrees and a distance of 5 meters, a flat surface would have to be at least 10 meters wide.

Something like this can hardly be realized with typical calibration bodies. Using projectors, large walls can simply be used, for example. Room corners or the like can also be used. In principle, the surface does not play a role, but shadowing effects must not occur.

An example is a curtain 200 shown in FIG. 6. The only requirement is that with regard to the camera, surface and texture, the setup does not move during the acquisitions. It should be noted that instead of a flat wall, a random pattern is projected onto the curtain 200 here. These images were used to measure the pane and are to illustrate the independence of the method from highly accurate calibration bodies.

If several images with and without windshields with changed patterns are acquired when using projectors, the accuracy of the optical flow methods can often be increased even further by combining the results.

In the setup in FIG. 4, a highly textured surface was produced by printing a random texture with different spatial frequencies onto it. One alternative is to also use projectors to produce random textures with different spatial frequencies on non-textured surfaces. In this case, several projectors may also be combined. This can be very useful to produce the necessary coverage for cameras with large aperture angles. Alternatively, monitors or screens may also be used. Many naturally occurring textures are also suitable for the method, such as an asphalt surface, mottled carpets, painter's fleece, or some house facades.

A flat surface does not necessarily have to be used. Especially in the case of cameras with a large aperture angle, curved surfaces or room corners may be ideal.

Of course, the method can also be used with other glass panes or optical elements.

It should furthermore be noted that in some applications, mirrors are used to lengthen the optical path. In principle, this method can also be used to determine the influence of imperfections in the mirror.

The method presented can be used by companies for measuring windshields, in particularly internally. The goal in this respect may be to generate statistics about windshields and to return this information to the development process. A large number or all produced windshields can thus be measured and classified or released according to the result.

1-10. (canceled)

11. A method for measuring an influence of a transparent pane in which a displacement field induced by the pane is determined, the method comprising the following steps:
acquiring a first image of a textured surface without the transparent pane;
acquiring a second image of the textured surface with the transparent pane; and
determining the displacement field by analyzing the first and second images using an optical flow method.

12. The method according to claim 11, wherein the textured surface is produced by projecting a texture onto a surface.

13. The method according to claim 11, wherein the textured surface has strong local contrasts.

14. The method according to claim 11, wherein the textured surface is defined by a pattern that has different local spatial frequencies.

15. The method according to claim 11, wherein several images, with and without the transparent pane and a respective changed textured surface, are acquired and the images are respectively combined in the determination.

16. The method according to claim 11, wherein at least one mirror is additionally used.

17. The method according to claim 16, wherein the method is used to determine an influence of imperfections in the at least one mirror.

18. The method according to claim 11, wherein the method is used to classify the measured transparent pane.

19. An arrangement for measuring an influence of a transparent pane, the arrangement configured to:
acquire a first image of a textured surface without the transparent pane;
acquire a second image of the textured surface with the transparent pane; and
determine a displacement field inducted by the pane by analyzing the first and second images using an optical flow method.

20. The arrangement according to claim 19, comprising a camera.
